(19) United States
(12) Patent Application Publication
(10) Pub. No.: US 2026/0312268 A1
(43) Pub. Date: Oct. 8, 2026

(54) MODULAR RF POWER SWITCH MATRIX

(71) Applicant: SPINNER GmbH, MÜNCHEN (DE)

(72) Inventors: Josef Landinger, Aschau (DE); Christoph Neumaier, Baiern (DE); Werner Blabsreiter, Großkarolinenfeld (DE); Michael Lege, Brukmühl (DE); Anton Lindner, München (DE)

(21) Appl. No.: 19/098,527

(22) Filed: Apr. 2, 2025

(30) Foreign Application Priority Data
Apr. 2, 2025 (EP) 25167883.5

(51) Int. Cl. H01P 1/10; H01H 1/14

(52) U.S. Cl. CPC H01P 1/10; H01H 1/14

(57) ABSTRACT

A coaxial RF switching matrix includes a plurality of switch modules arranged on both sides of a base plate and interconnected with each other through the base plate. The switch modules have four ports and a switch for alternate connections of a first port to a third port or a fourth port and a second port to the fourth or third port. The coaxial RF switching matrix also includes a base plate having a first side and a second side with a first group of switch modules attached to the first side of the base plate and a second group of switch modules is attached to the second side of the base plate such that at least one switch module of the first group of switch modules is connected through the base plate to at least one switch module of the second group of switch modules.

### CROSS-REFERENCE TO RELATED APPLICATIONS

This US patent application claims priority from and benefit of the European Patent Application No. EP 25167883.5 filed on Apr. 2, 2025, the disclosure of which is incorporated by reference herein.

### FIELD OF THE INVENTION

The invention relates to a modular RF power switch matrix which may be used to connect multiple transmitters/receivers to multiple antennas.

### DESCRIPTION OF THE RELATED ART

RF switch matrices are comparatively large and complex. In a switching matrix, multiple first lines are connectable to multiple second lines. The lines may be coaxial lines and have coaxial connectors. In the switch it is essential to maintain the characteristic impedance of the coaxial system, thus keeping reflection and losses low. Further, a high isolation should be maintained between channels which are not intended to be connected together. A matrix switch is disclosed in U.S. Pat. No. 4,829,271. This matrix switch is designed for a specific configuration which cannot be changed without re-engineering of the housing and the internal structures.

### SUMMARY OF THE INVENTION

The problem to be solved by the invention is to provide an RF matrix switch, which can be adapted to different configurations.

Solutions of the problem are described in the independent claims. The dependent claims relate to further improvements of the invention.

In an embodiment, an RF switch includes a plurality of switch modules which are mounted to a base plate. The base plate holds the switch modules in place and helps connecting them together. Each switch module may have four ports and a switch. Each switch may have two switching states:

In a first state, a first port is connected to a third port and a second port is connected to a fourth port.

In a second state, the first port is connected to the fourth port and the second port is connected to the third port.

In any of these states, there is no connection between the first and second port.

There may be an alternate switch configuration where in the second state, the first port is connected to the second port and the third port is connected to the fourth port. This switch configuration allows basically to configure the same switching matrix. Further, at least one switch may have three states including the first state and the normal and the alternate second state. For simplicity, herein only the first configuration is described, although the alternate switch configuration may be used instead.

The connection may be made by electronic or mechanical switches, e.g., relays or other contacts. Mechanical switches have the advantage that they are capable of higher power levels.

The coaxial RF switching matrix further includes a base plate having a first side and opposing thereto a second side. A first group of switch modules may be attached or mounted to the first side of the base plate, and a second group of switch modules may be attached or mounted to the second side of the base plate (100). At least one switch module of the first group of switch modules may be connected through the base plate to at least two, three or four switch modules of the second group of switch modules. The arrangement may be such that such that at least one of the ports of a switch module on the first side contacts a different switch module on the second side. E.g. one port of a switch module on the first side may contact another switch module on the second side. Each of two ports of a switch module on the first side may contact one of two different switch modules on the second side. Each of three ports of a switch module on the first side may contact one of three different switch modules on the second side. Each port of a switch module on the first side may contact a different switch module on the second side and/or vice versa.

At least one and optionally two, three or all of the ports have a center conductor. At least one of the switch modules of the first group of switch modules may have at least one first center conductor which is configured to contact a second center conductor of one of the switch modules of the second group of switch modules. At least one first center conductor may have a female contact interface, and the second center conductor may have a male contact interface or vice versa. In an embodiment, at least one or each switch module may have two male center conductors, and two female center conductors alternatingly arranged. In an alternate embodiment, the at least one first center conductor and the second center conductor may have hermaphroditic contact interfaces. Such interfaces can contact with the same type of contact interface, such that only one type of contact interface is needed.

The switch modules may have a mounting base from which four center conductors of the ports protrude. Around the center conductors may be circular protrusions in the mounting base, forming outer conductors of coaxial line systems together with the center conductors. There may be contacting rings around the circular protrusions of the mounting base configured to contact the base plate. These may result in a better electrical connection between the switch module and the base plate, with a protrusion, which also serves as an outer conductor of the coaxial system.

The mounting base may have a square cross section on which the center contacts may be arranged symmetrically to the center of the square of the mounting base. A square shape of the mounting base allows a dense arrangement of a large number of switch modules in a matrix pattern. Instead of a square shape, basically any other shape, e.g. rectangular or circular may be used. The switch modules on the second side may be displaced about half the side length of the mounting base in directions of a first and an orthogonal second axis of the mounting base which may be parallel to edges of the mounting base.

The mounting base may include mechanical positioning pins. It may further include at least one orientation device (e.g. pins, special shaped bodies) and/or at least one fixation device, e.g. a screw or bolt or a locking device, e.g. having a bayonet lock.

The switch modules are mounted to a base plate and held thereon, e.g., by a centered mounting device or mounting screw. There is a first group of switch modules on a first side of the base plate and a second group of switch modules on the opposing side of the base plate. The switch modules on the opposing side may be displaced by about half the side length of the mounting base in directions of a first axis and an orthogonal second axis of the mounting base which may be parallel to edges of the mounting base. By such a configuration, each switch module on the second side may contact four switch modules on the first side. By this way, a large number of possible connections and configurations can be achieved.

The same principle is applicable to other configurations of switch modules and base plates. For example, three port switches may be used in a triangular configuration or six port switches in a hexagonal configuration.

The mounting base of each switch may have additional features. For example, a positioning means may be provided to position the switch module precisely at a predetermined position of the base plate. Further, an orientation means may be provided, allowing to place a switch module only in a predetermined orientation on the base plate. This may be important, as the switch modules may have male and female port connectors. In such a case it must be avoided that a male connector touches another male connector, or a female connector touches a female connector, as this may lead to damage of the connectors. Further, a locking means may be provided to lock the switch modules to the base plate.

In an embodiment, an interlock means may be provided. Such an interlock means may give a signal, if the switch is in a switching state and therefore in an undefined position. Normally, during switching, all contacts are opened and later closed in a new configuration. If a high-power transmitter is connected to a switch and supplying high power RF signals into the switch during a switching process, the switch and/or the transmitter may be damaged, specifically when opening closed contacts. An interlock signal which indicates that the switch is in a switching or transient configuration may be used to disable the transmitter, such that there are no high voltages at the switch during a switching operation. There may be at least one interlock contact pin at the mounting base which provides a contact to another switch module at the opposing side of the base plate. By the way, an interlock signal may be looped through all switch modules, if an interlock input and an interlock output pin are provided.

In an embodiment, a terminal connector may be provided and configured to contact at least one center conductor of at least one switch module and connecting the at least one center conductor to a coaxial connector. This may allow for an external connection, e.g.

ae which may lead to a transmitter/receiver or an antenna. Further, a load or termination may be connected. A terminal connector may also include a termination.

In an embodiment, the switch modules may have a bus or network interface and may be connected to a control unit configured to configure or set up the individual switch modules of the RF switching matrix.

### BRIEF DESCRIPTION OF DRAWINGS

In the following the invention will be described by way of example, without limitation of the general inventive concept, on examples of embodiment with reference to the drawings.

FIG. 1 shows a total view of an RF switching matrix.

FIG. 2 shows a switch module.

FIG. 3 shows the mounting base of a switch module.

FIG. 4 shows an external connector.

FIG. 5 shows a bottom view of an external connector.

FIG. 6 shows a base plate 100.

FIG. 7 shows a schematic switch configuration.

FIG. 8 shows a physical layout

FIG. 9 shows a schematic of the physical embodiment of FIG. 8

FIG. 10 shows routing of signals through the switching matrix

### DETAILED DESCRIPTION

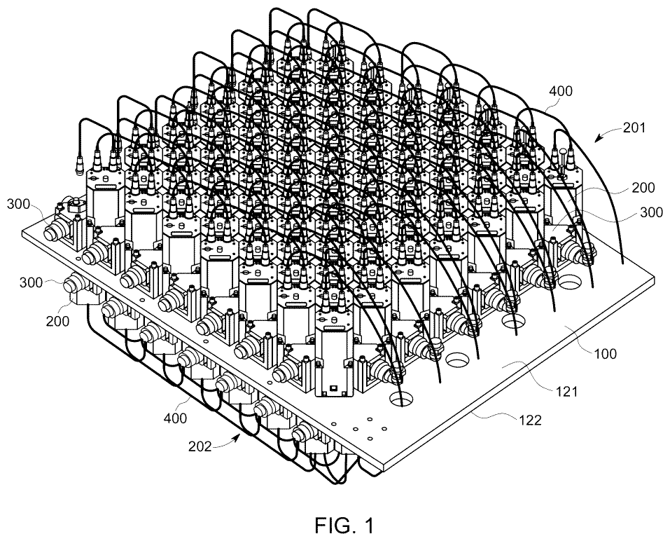

FIG. 1 shows a total view of an RF switching matrix 400. The RF switching matrix 400 includes a plurality of switch modules 200 which are mounted on a base plate 100. The switch modules 200 may have a square cross-section base such that they can be mounted side by side in a diagonally shaped matrix arrangement. A first group 201 of switch modules 200 is on a first side 121, here shown as top of the base plate 100 and a second group 202 of switch modules 200 is on the opposing second side 122, here shown as bottom of the base plate 100. Top and bottom may be exchanged. For simplicity, in the figure description, the terms top and bottom are used for first side and second side. The first group 201 of switch modules 200 on the first side 121 are displaced against the second group 202 of switch modules 200 of the second side 122 by half the length of a switch module mounting base. This results in a configuration where each switch module on the first side may contact four different switch modules on the second side.

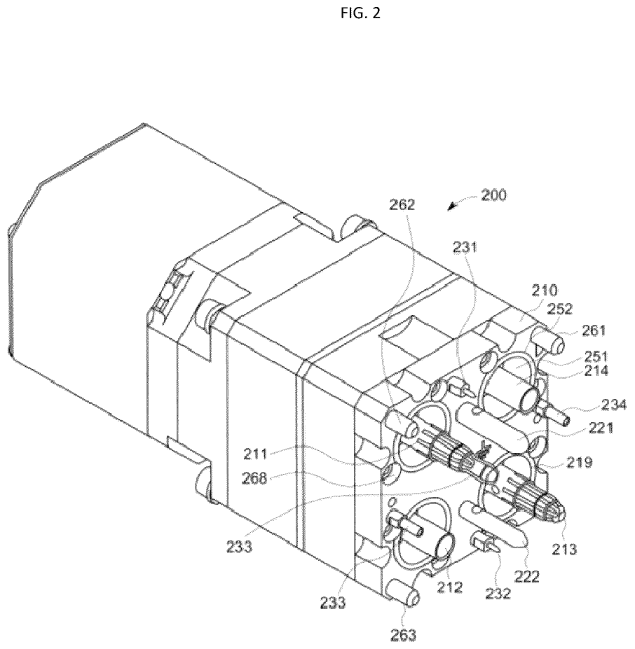

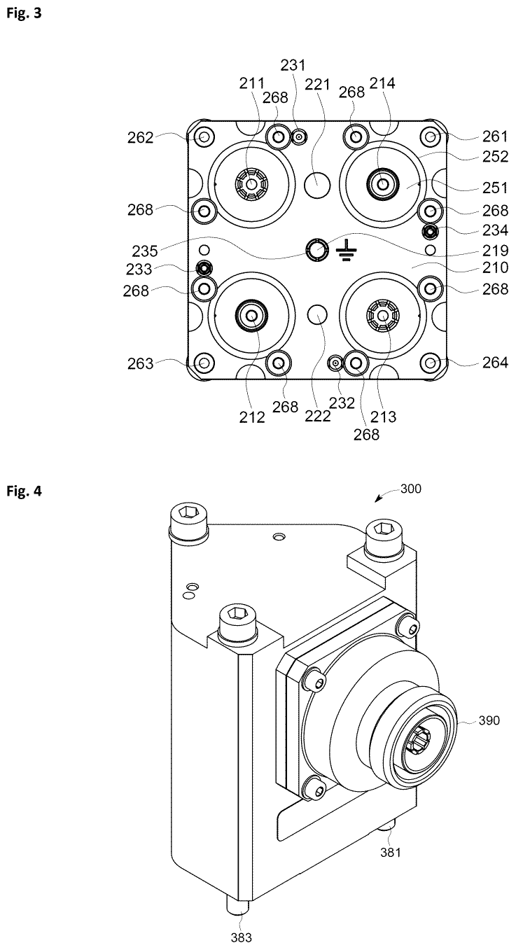

In FIGS. 2 and 3, a switch module 200 is shown. FIG. 2 shows a total view whereas FIG. 3 shows a view of the mounting base 210. The switch module 200 may have a mounting base 210. This mounting base 210 may have a squared shape and provides an interface to the base plate 100. The mounting base bears the body of the switch module which may include electrical or mechanical RF switches, and an electrical and/or mechanical drive system for the switches. It may further bear a network or bus interface for controlling the switch module and further optional means for manually operating the switch module and/or indicating the status of the switch module.

Through the mounting base 210 protrude four coaxial center conductors forming center contacts 211, 212, 213, 214. These center conductors may be in circular protrusions 251 of the mounting base 210, forming a coaxial system. Each of the circular protrusion 251 may have a contacting ring 252. The contacting rings 252 may only slightly protrude from the mounting base 210 to provide a small circular contact area with a comparatively high pressure to provide a low resistance contact to the base plate 100. The contacting ring may be configured for providing a good electrical contact with the base plate at a circular protrusion 110, 111, 112, 113 through the base plate 100 through which the center conductors protrude, when a switch module is mounted to the base plate 100. These protrusions provide a fully closed outer conductor and a coaxial system between switch modules on both sides of the base plate.

The center contacts may have different configurations. In the embodiment shown here, a first center contact 211 and a third center contact 213 have female contact interfaces whereas a second center contact 212 and a fourth center contact 214 have male contact interfaces. This allows to use one type of switch module which can be used on both sides of the base plate such that a male center contact matches to a female center contact on the other side of the base plate.

At the mounting base, there may be a fixation device 235, which may be a screw configured to hold the switch module at the base plate. Such a screw may go through the hole body of the switch module and may be accessed by a screwdriver or another tool from the top of the switch module housing.

For an interlock configuration, there may be interlock connecting pins 231, 232, 233 and 234. These pins may be used for daisy-chaining interlock switches which are in the switch modules and which may be operated when the RF switch is in an undefined or open state. With such a daisy chain connection, the interlock switches in a plurality or all of the switch modules may be connected in series and to an external device, e.g. a controller or transmitter. By such an interlock signal, any RF power source, e.g., transmitter, may be switched off to avoid high voltages at an opening or closing switch during operation. This may prevent damaging the switching matrix.

Beyond the electrical contacts, there may be at least one mechanical positioning pins 261, 262, 263 and 264. Further, may be orientation devices 221, 222 which may prevent inserting a switch module in a wrong configuration and/or at a wrong position, such to avoid damage of the center conductors.

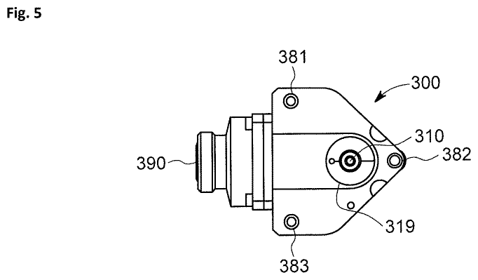

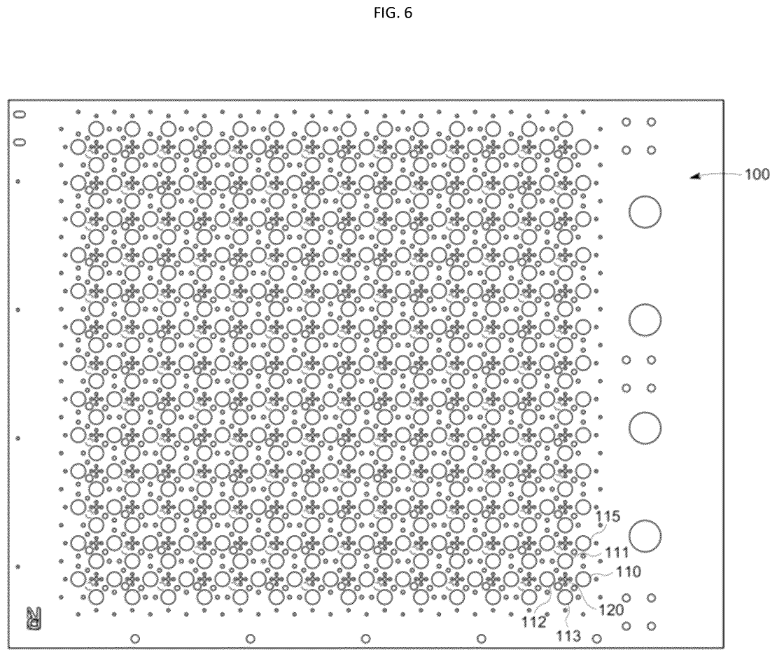

FIGS. 4 and 5 show an external connector 300. For connecting sources and/or loads, e.g., transmitters/receivers and antennas to the switching matrix, external connectors 300 may be provided. These external connectors can be provided at the sides of the matrix in the gaps forming between the switch modules. The external connectors can be mounted on either side of the base plate. Basically, they have a matching coaxial interface which may include either a male or a female center conductor protruding the mounting base of the external connector. This center conductor can contact a center conductor of a switch module on the other side of the base plate. The center conductor may be connected to a coaxial connector 390.

There may be mechanical positioning pins 381, 382, 383. There may also be interlock contacting pins for contacting the interlock switches, such that the interlock signals can be provided to an external interlock connector.

FIG. 6 shows a base plate 100. It has a regular, preferably squared pattern of holes for mounting switch modules and optional external connectors. The base plate 100 may have circular protrusions 110, 111, 112, 113 through which the center conductors of switch modules protrude, when a switch module is mounted to the base plate 100. There may further be holes for interlock connecting pins 115 and locking holes 120 for locking means of the switch modules.

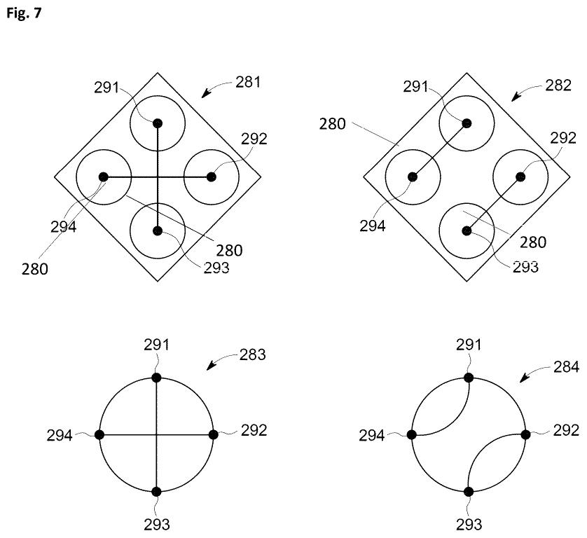

In FIG. 7, a schematic switch configuration is shown. The top diagrams show a switch module in two different switching states. The square frame indicates the housing contour of an exemplary square cross sectioned switch module which may also be round or have any other shape. The big circles indicate the port positions, and the small dots are the ports. On top is a first port 291, to the right is a second port 292. At the bottom is a third port 293 and at the left is a fourth port 294. These ports are depending on the switching state connected by switches 280.

In a first switching state 281 as shown in the left top diagram, first port 291 is connected to third port 293 and second port 292 is connected to fourth port 294. In the right diagram, a second switching state is shown. Here, the first port 291 is connected to the fourth port 294 and the second port 292 is connected to a third port 293. For building a coaxial RF switching matrix, the switching states shown are sufficient. For the second switching state, there may be an alternate state which is not shown in here. In this state, the first port 291 is connected to the second port 292 and the fourth port 294 is connected to the third port 293. For this, the switch may simply be rotated about 90° in any direction. In an embodiment, at least some switch modules may have a third switching state which corresponds to the alternate state.

It should be noted that only two ports are connected to each other. The pairs of ports are not interconnected. Therefore, in the first state, there is no connection between first port 291 and second port 292 or fourth port 294. First port 291 is only connected to third port 293. And electrically independent from that second port 292 is connected to fourth port 294. In the second state, there is no connection between the first port 291 and the second port 292. The first port 291 is only connected to fourth port 294 but not to third port 293 and second port 292. Electrically independent from that second port 292 is connected to third port 293.

The bottom diagrams schematically show the switching states as shown above. They are here shown for reference and will be used later. Again, in the first state, first port 291 is connected to third port 293 and second port 292 is connected to fourth port 294 as shown in schematic 283. Further, schematic 284 shows the first port 291 connected to fourth port 294 and second port 292 connected to third port 293.

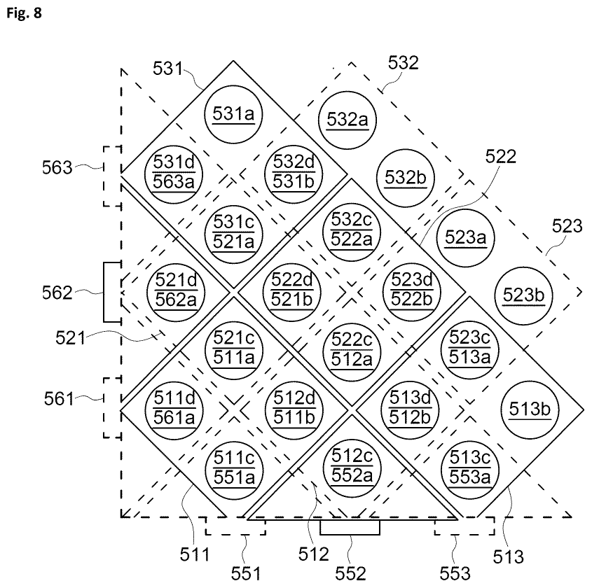

In FIG. 8, a sketch of a typical physical layout is shown. This schematic shows eight switch modules. There are four switch modules on the top of the base plate drawn with straight lines. The other four modules drawn with dashed lines are on the bottom of the base plate. On the top of the base plate are switch modules 511, 513, 522 and 531, whereas at the bottom are the switch modules 512, 521, 523 and 532. Further, external connectors are shown. External connectors 552 and 562 with straight lines are on top of the base plate, whereas external connectors 551, 553, 561 and 563 shown in dashed lines are at the bottom of the base plate. This figure clearly shows the displacement of the switches at the top side against the switches at the bottom side of the base plate. The displacement is such that each port of a switch module on the top side contacts a different switch module on the bottom side and vice versa.

This may allow a meshing of the switch modules such that signals can be routed from one side of the switching matrix to another side. This connection is indicated by the numbers of the related ports in the big circles which are within the squares indicating a switch module. For example, the switch module 511 has on top a port 511a which contacts ports 521c which is the third port of switch module 521. On the right side there is port 511b which contacts port 512d of switch module 512 which is the fourth port of switch module 512. The third port of switch module 511, port 511c is connected to the external connector 551 with its port 551a. The fourth port 511d is connected to the external connector 561 by its port 561a. In this figure, the first ports are marked by the letter a after the number of the switch module, the second ports have letter b, third ports letter c and the fourth ports letter d. The diagram as shown can be extended to any size as desired to the top and to the right. In here, only the left bottom corner is shown. Of course, there can be multiple external connectors on the right side or at the top side. This is not shown here for simplification. The embodiment of FIG. 1 shows an array with seven switch modules on the top and the same number of switch modules at the bottom.

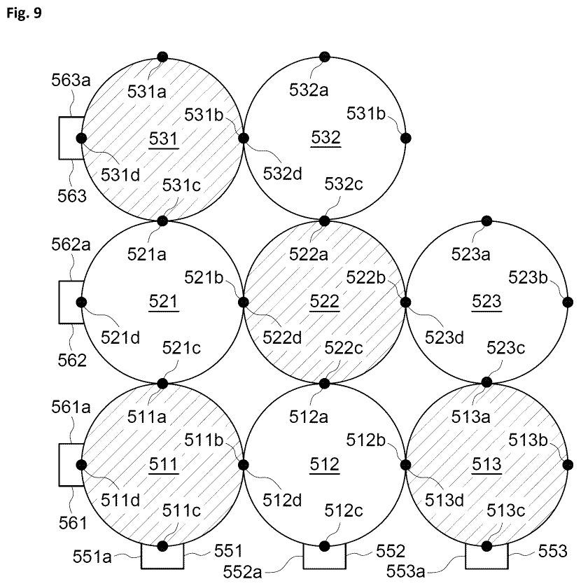

FIG. 9 shows a schematic of the physical embodiment of FIG. 8. Here, the individual switches are shown as diagrams similar to FIG. 7. The hatched switches are on the top side whereas the other switches and external connectors are on the bottom side.

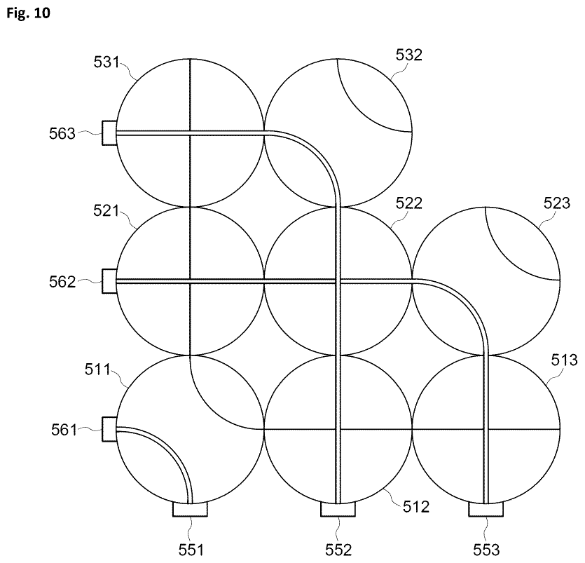

FIG. 10 shows in an exemplary embodiment routing of signals through the switching matrix. A first signal is routed between the external connectors 551 and 561 by the first switch module 511 which is in a second switching state. A second signal is routed from between the external connectors 552 and 563 by means of the switch modules 512, 522, 532 and 531. Only the switch module 532 is in its second switching state whereas the other switches are in the first state. Finally, there is a connection between the external connectors 553 and 562 via the switch modules 513, 523, 522 and 521. The switch module 523 is in its second switching state whereas the other switches are in the first switching state. As mentioned before, there is no interconnection between the signal paths in a switch and therefore the two signal paths can cross through switch module 522 without being connected to each other. In an example, transmitters and receivers may be connected to the external connectors 551, 552 and 553 whereas antennas may be connected to the external connectors 561, 562 and 563. Due to the switch configuration shown here, signals may only be routed from a first side of the matrix (here the bottom side) to one side of the matrix orthogonal to the first side of the matrix (here the left side) and vice versa. Routing from the first side to the opposing orthogonal side may require the alternate second state configuration or a three state switch. The same would apply for connections between the top side of the matrix and the right side of the matrix. There is one exception with a signal routed straight through the matrix to the opposing side of the matrix.

List of reference numerals

| | |
|---|---|
| 100 | base plate |
| 110 | first protrusion forming outer conductor |
| 111 | second protrusion forming outer conductor |
| 112 | third protrusion forming outer conductor |
| 113 | fourth protrusion forming outer conductor |
| 115 | holes for interlock connecting pins |
| 120 | locking holes |
| 121 | first side of baseplate |
| 122 | second side of baseplate |
| 200 | switch module |
| 201 | first group of switch modules |
| 202 | second group of switch modules |
| 210 | mounting base |
| 211 | first center conductor |
| 212 | second center conductor |
| 213 | third center conductor |
| 214 | fourth center conductor |
| 219 | switch center |
| 221 | first orientation device |
| 222 | second orientation device |
| 231 | first interlock connecting pin |
| 232 | second interlock connecting pin |
| 233 | third interlock connecting pin |
| 234 | fourth interlock connecting pin |
| 235 | fixation device |
| 241 | bus connector |
| 242 | configuration switch |
| 243 | switch state indicator |
| 251 | circular protrusion |
| 252 | contacting ring |
| 261 | first mechanical positioning pin |
| 262 | second mechanical positioning pin |
| 263 | third mechanical positioning pin |
| 264 | fourth mechanical positioning pin |
| 267 | screw |
| 280 | switch |
| 281 | first switching state |
| 282 | second switching state |
| 283 | schematic of first switching state |
| 284 | schematic of second switching state |
| 291 | first port |
| 292 | second port |
| 293 | third port |
| 294 | fourth port |
| 300 | terminal connector |
| 310 | center conductor |
| 319 | circular protrusion |
| 381 | first mechanical positioning pin |
| 382 | second mechanical positioning pin |
| 383 | third mechanical positioning pin |
| 390 | coaxial connector |
| 400 | switching matrix |

1. A coaxial RF switching matrix comprising:
at least three switch modules,
each of the at least switch modules comprising four ports and a switch,
the switch having at least two switching states, wherein:
in a first switching state of the at least two switching states, a first port of the four ports is connected with a third port of the four ports and a second port of the four ports is connected with a fourth port of the four ports, and
in a second switching state of the at least two switching states, the first port is connected with the fourth port and the second port is connected with the third port;
a base plate having a first side and opposing thereto a second side,
wherein:
a first group of the at least three switch modules is attached to the first side of the base plate, and
a second group of the at least three switch modules is attached to the second side of the base plate, and
at least one switch module of the first group of the at least three switch modules is connected through the base plate to at least one switch module of the second group of the at least three switch modules.

2. A coaxial RF switching matrix according to claim 1,
characterized in, that
at least one switch module of the first group is connected through the base plate to four switch modules of the second group.

3. A coaxial RF switching matrix according to claim 1,
characterized in, that
at least one of the four ports has a center conductor, and
at least one of switch modules of the first group comprises at least one first center conductor that is configured to contact a second center conductor of one of the switch modules of the second group.

4. A coaxial RF switching matrix according to claim 3,
characterized in, that
the at least one first center conductor has a female contact interface and the second center conductor has a male contact interface or vice versa.

5. A coaxial RF switching matrix according to claim 3,
characterized in, that
each of the at least three switch module comprises two male center conductors and two female center conductors alternatingly arranged.

6. A coaxial RF switching matrix according to claim 3,
characterized in, that
the at least one first center conductor and the second center conductor have hermaphroditic contact interfaces.

7. A coaxial RF switching matrix according to claim 3,
characterized in, that
a terminal connector is provided and configured to contact at least one center conductor of at least one of the at least three switch modules and to connect the at least one center conductor to a coaxial connector or to a termination.

8. A coaxial RF switching matrix according to claim 1,
characterized in, that
a switch module of the at least three switch modules have a mounting base with a rectangular, square, or circular cross-section.

9. A coaxial RF switching matrix according to claim 1,
characterized in, that
the mounting base has circular protrusions forming outer conductors for center conductors of a switch module of the at least three switch modules.

10. A coaxial RF switching matrix according to claim 8,
characterized in, that
the mounting base includes mechanical positioning pins.

11. A coaxial RF switching matrix according to claim 1,
characterized in, that
switch modules of each of the first and second groups of the at least three switch modules are arranged side by side in a matrix pattern.

12. A coaxial RF switching matrix according to claim 1,
characterized in, that
the at least three switch modules have a bus or network interface and are connected to a control unit configured to set up the individual switch modules of the RF switching matrix.

13. A coaxial RF switching matrix according to claim 1,
characterized in, that
the at least three switch modules have an interlock switch configured to signal an undefined or open state of a switch.

14. A coaxial RF switching matrix according to claim 1,
characterized in, that
a switch module of the at least three switch modules have at least one interlock connecting pin configured to connect the interlock switch with another switch module of the at least three switch modules.

15. A coaxial RF switching matrix comprising:
at least three switch modules, wherein
each of the at least three switch modules comprises four ports and a switch;
and
a base plate having a first side and opposing thereto a second side;
wherein:
a first group of the at least three switch modules is attached to the first side of the base plate, and
a second group of the at least three switch modules is attached to the second side of the base plate, and
at least one switch module of the first group is connected through the base plate to at least one switch module of the second group
such that at least one of the four ports of a switch module on the first side contacts a different switch module on the second.

16. A coaxial RF switching matrix according to claim 15,
wherein the switch of said each of at least three switch modules has at least two switching states,
wherein:
in a first switching state of the at least two switching states, a first port of the four ports is connected with a third port of the four ports and a second port of the four ports is connected with a fourth port of the four ports, and
in a second switching state of the at least two switching states, the first port is connected with the fourth port and the second port is connected with the third port.

17. A coaxial RF switching matrix according to claim 9, further comprising contacting rings around the circular protrusions of the mounting base, said contacting rings dimensioned to contact the base plate.

18. A coaxial RF switching matrix according to claim 10, wherein
the mounting base includes orientation devices and/or at least one fixation device.

19. A coaxial RF switching matric according to claim 11,
wherein a switch module on the second side of the base plate is displaced about half a side length of a mounting base of said switch in directions of a first axis of the mounting base and a second axis of said mounting base that is orthogonal to the first axis of said mounting base.
